(19) United States
(12) Patent Application Publication
(10) Pub. No.: US 2006/0179592 A1
(43) Pub. Date: Aug. 17, 2006

(54) Wrist and forearm support device connectable to a standard paint roller assembly

(76) Inventor: Jason A. Landers, Atlanta, IN (US)

Correspondence Address: Gregory P. Gadson, Esq., 19375 Amber Way, Noblesville, IN, 46060, US

(21) Appl. No.: 11/057,944

(22) Filed: Feb. 15, 2005

(51) Int. Cl. B05C 17/02

(52) U.S. Cl. 15/143.1; 15/230.11; 15/144.1

(57) ABSTRACT

An apparatus for cooperative operation with a paint roller assembly at least includes: a main member; a first end member coupled to the main member, the first end member adapted to be secured to the end of the handle of a paint roller assembly; and a second end member coupled to the main member, the second end member at least partially spanning across a projected region. The second end member is adapted to accommodate and support a forearm during painting activities.

### FIELD OF THE INVENTION

The present invention generally relates to paint roller assemblies and the like. More particular, the present invention relates to approaches for reducing or eliminating skeletal-muscular discomfort, pain or injury associated with the prolonged use of conventional paint roller assemblies.

### BACKGROUND OF RELATED ART

As is well know, conventional paint roller assemblies are used to manually apply relatively large amounts of paint onto a surface by applying pressure to a paint-drenched roller engaged with the surface, and simultaneously pushing the roller orthogonally with respect to the roller's axis of rotation. After the paint on the roller is sufficiently depleted, it is then replenished, followed by a repeat of the aforementioned steps (pressing accompanied by pushing or pulling along the surface to cause the paint roller to rotate) until the surface is painted as desired.

Conventional paint roller assemblies, as typified by the illustration numbered 100 in FIG. 1, consist of a paint roller 110, a question mark-shaped paint roller frame 140 (often, but not necessarily constructed of metal), paint roller wheels 120 and 130 to suspend and axially affix the paint roller 110 on the paint roller frame 140, and a paint roller handle 150 connected to the otherwise free end of the paint roller frame 140. It is also commonplace for the paint roller handle 150 to contain a grooved cavity 160 for accepting a screw-in extension rod (not shown) when a painter needs extra reach during painting.

Especially when painting without the extension rod (where two hands are normally used), the combination of applying constant pressure on the painting surface and the constant pushing and pulling of the roller can lead to stress on the wrist and forearm of a painter. Exacerbating the above is the fact that the wrist is not held at an optimum angle with respect to the handle (a wrist in a position where the hand is more axially aligned with the forearm would be more ergonomically advantageous). Such stress to the muscles and ligaments around the carpel, ulna, and radius bones have been linked to skeletal-muscular problems ranging from muscle aches and pains, to bursitis (including bursitis of the elbow), to repetitive motion injuries like carpel tunnel syndrome.

In view of the aforementioned problems associated with using conventional paint roller assemblies, and the failure of prior art to address these problems, there is an unmet need to eliminate or greatly reduce the negative skeletal-muscular consequences associated with the operation of conventional paint roller assemblies.

### SUMMARY

In view of the above-identified problems not addressed by the prior art, the present invention provides an apparatus for cooperative operation with a paint roller assembly, in which the apparatus at least includes: a main member; a first end member coupled to the main member, the first end member adapted to be secured to the end of the handle of a paint roller assembly; and a second end member coupled to the main member, the second end member at least partially spanning across a projected region. The second end member is adapted to accommodate and support a forearm during painting activities.

The present invention also provides an apparatus for cooperative operation with a paint roller assembly, in which the apparatus at least includes: a main member; a first end member coupled to the main member, the first end member adapted to be secured to the end of a paint roller assembly handle; a second end member coupled to the main member, the second end member at least partially spanning across a projected region; and an oblique member making an oblique angle relative to the paint roller assembly handle, and coupled between the first end member and the main member. The oblique member is adapted to be grasped during painting activities, and the second end member is adapted to accommodate and support a forearm during painting activities.

### BRIEF DESCRIPTION OF THE DRAWINGS

Features of the present invention will become apparent to those skilled in the art from the following description with reference to the drawings, in which:

FIG. 1 is a top view of a prior art conventional paint roller assembly;

FIG. 2 is top view of a preferred embodiment of the present-inventive wrist and forearm support device, shown operatively coupled to a conventional paint roller assembly;

FIG. 3 is a side view of the wrist and forearm support device shown in FIG. 2;

FIG. 4 is a top view and a rear view of a first alternate embodiment of the present-inventive wrist and forearm support device;

FIG. 5 is a top view of a second alternate embodiment of the present-inventive wrist and forearm support device;

FIG. 6 is a top view of a third alternate embodiment of the present-inventive wrist and forearm support device;

FIG. 7 is a side view of the wrist and forearm support device of FIG. 6 as a whole, and a back view of the pivot and locking mechanism of the aforementioned wrist and forearm support device;

FIG. 8 is a top view of a fourth alternate embodiment of the present-inventive wrist and forearm support device;

FIG. 9 is a rear view of the wrist and forearm support device shown in FIG. 8;

FIG. 10 is a top view of a fifth alternate embodiment of the present-inventive wrist and forearm support device;

FIG. 11 is a rear view of the wrist and forearm support device shown in FIG. 10;

FIG. 12 is a side view of a sixth alternate embodiment of the present-inventive wrist and forearm support device;

FIG. 13 is a top view of the wrist and forearm support device shown in FIG. 12; and

FIG. 14 is a rear view of the wrist and forearm support device shown in FIG. 12.

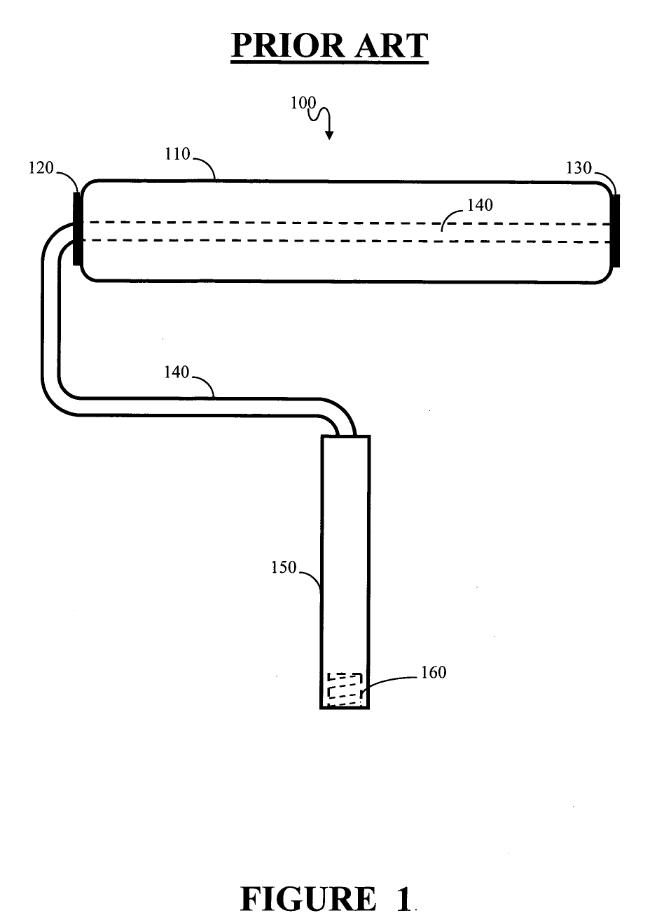

### DETAILED DESCRIPTION

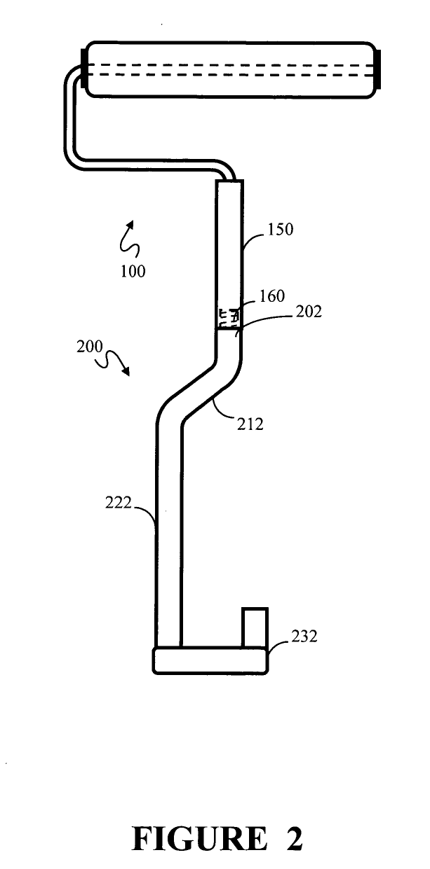

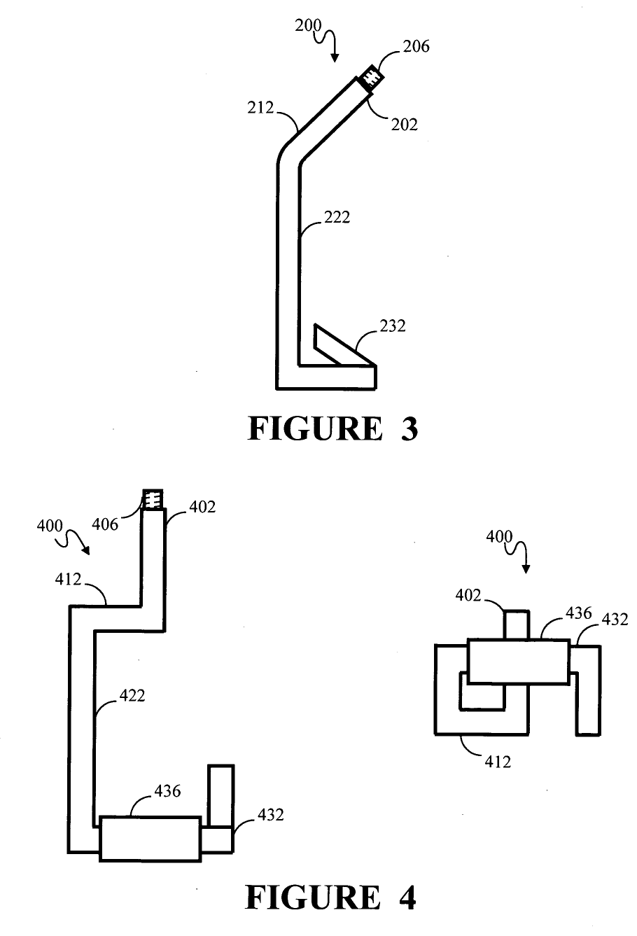

A preferred embodiment 200 for the present-inventive wrist and forearm support device for operative coupling to a conventional paint roller assembly is shown in FIG. 2 connected to a paint roller assembly, and shown by itself in FIG. 3. In the preferred embodiment, the support device 200 is constructed from metal for structural strength, although non-metallic material can also be used. In its simpler version, the support device 200 can be formed from one piece of stock metal, or molded as one piece.

A first end member 202 of the support device connects to the handle 150 of the paint roller assembly. A front end member coupler 206 contains threads which are inserted into the paint roller assembly receptacle 160, and rotated to form the connection. In the preferred embodiment, an oblique member 212 is located between the front end member 202 and a main member 222. A c-shaped back end member 232 provides support for a painter's forearm. During painting, the painter can grasp the oblique member 212 for a straighter wrist orientation, or grasp the paint roller assembly handle if that is more advantageous.

Given the above teachings, many other configurations are possible. For example, a different version of a wrist and forearm support device 400 is shown in the top and rear view illustrations of FIG. 4. The bends in the support device are mostly 90 degrees. The elements 402, 406, 412, 422 and 432 are analogous to the elements 202, 206, 212, 222 and 232 on the device 200 in FIG. 2. The support device 400 also contains padding 436 for more comfortable contact between a forearm and the back end member 432.

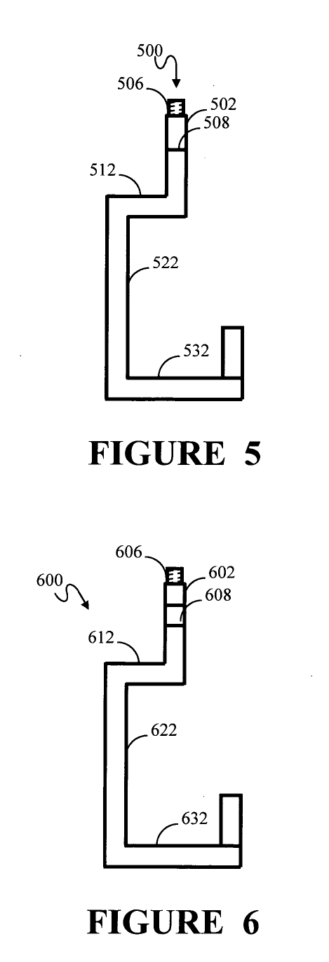

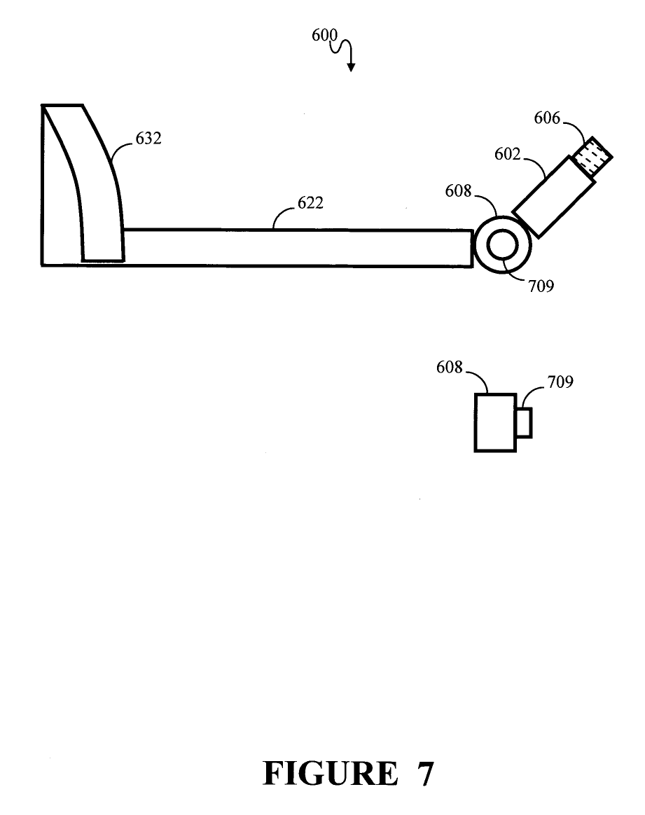

Yet another alternate embodiment 500 for the present-inventive wrist and forearm support device is shown in FIG. 5. The addition of a pivot mechanism 508 allows the support device to have a snug fit with the paint roller assembly handle, and yet facilitate unlimited axial rotation of the support device, as may be desired during painting. A simple rivet or washer-nut combination can serve as the pivot mechanism.

In still another alternate embodiment 600 shown in FIG. 6, a wrist and forearm support device has a pivot mechanism that allows three degrees of freedom—rotation along the longitudinal axis of the device, and lateral and pitching movement when desired. This allows adjustment of the support device 600 into the most comfortable and effective position for individual painters. In addition, a locking mechanism allows the painter to lock the device into a desired position. Both the pivot mechanism and the locking mechanism are included in the same unit 608. However, the pivot and locking mechanisms may be separate units. A simple version of a pivot and locking unit is a ball and socket arrangement with an interference fit, and an attached locking bolt, as is well known in the art.

A detailed side view of the support device 600 is shown in FIG. 6—especially with respect to the pivot and locking mechanism 608. In another embodiment of the pivot and locking mechanism, the unit 608 contains a spring-loaded locking pin 709 which can be pulled away from the unit 608 to allow free rotation about the pivot. When the locking pin 709 is released, teeth (not shown) around the shaft of the locking pin engage with teeth (not shown) of the internal wall of the mechanism 608 to lock and set the relative angle between the first end member and the main member 622.

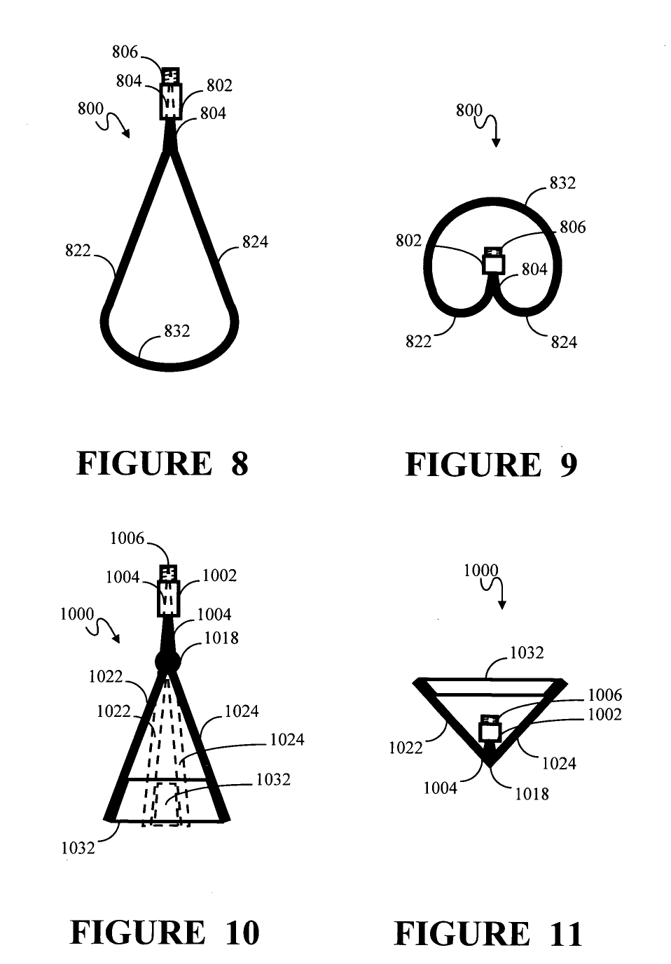

Yet another embodiment 800 of the present-inventive wrist and forearm support device is shown in FIGS. 8 and 9 (top view and rear view, respectively). A front end member 802 has on one end, a coupler 806, which is screwed into a paint roller assembly handle, and a structural member 804. The structural member 804 has a loop shape formed from two arms 822 and 824 and a back end portion 832. In this embodiment, the front end member 802 and the front end member coupler 806 are permanently connected, while the structural member 804 freely rotates within the elements 802 and 806.

The structural member 804 is composed of plastic for relatively low manufacturing costs, as well as a higher degree of flexibility than metal-only structural members. Those skilled in the art will appreciate that the structural member 804 can be steel- (or other metal) reinforced for added rigidity and structural integrity, if needed. The back end member 832 can also be padded.

A variation on the embodiment 800 of FIG. 8 is shown in FIGS. 10 and 11 (top view and rear view, respectively). In this case, a wrist and forearm support device 1000 is similar to the device 800, and has elements 1002, 1004, 1006, which are analogous to elements 802, 804, and 806, respectively. However, the structural member 1004 has two retractable fork members 1022 and 1024 which are joined by a pivot and locking mechanism 1018. A back end portion 1032 is constructed from non-rigid material such as fabric.

The fork members 1022 and 1024 retract toward an imaginary centerline of the device 1000 for convenient storage.

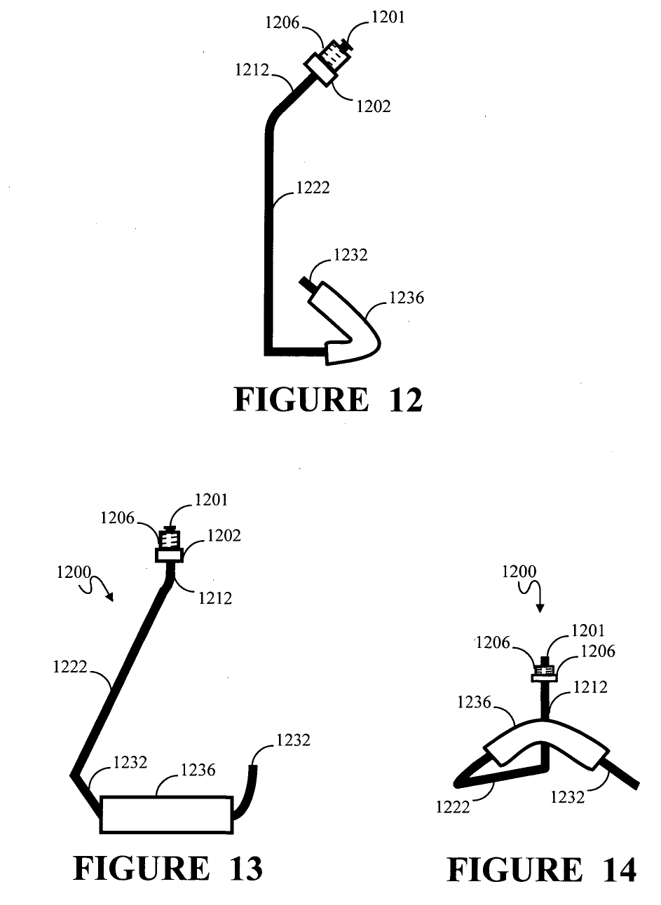

Still yet another embodiment of the present-inventive wrist and forearm support device 1200 is illustrated in the side view, top view and rear views of FIGS. 12, 13 and 14, respectively. This version may be thought of as a “triangular” design requiring less steel or other metals than some of the other embodiments, requiring fewer bends, and being easier to construct.

A cap 1201 fixes the structural member of the device inside a front end member 1202 and coupler 1206. The member and coupler 1202 and 1206 are hollow, allowing rotation of the structure when the device is coupled to a paint roller assembly. As can be seen from the rear view in FIG. 14, a back end member 1232 has a triangular shape. The embodiment 1200 also includes padding 1236 as illustrated. Finally, elements 1212 and 1222 function as similarly numbered structural members described supra.

Thus has been described, a wrist and forearm support device that can be conveniently coupled to the handle of a convention paint roller assembly, and that provides support to a painter's forearm and wrist, as well as more ergonomic hand positioning.

Variations and modifications of the present invention are possible, given the above description. However, all variations and modifications which are obvious to those skilled in the art to which the present invention pertains are considered to be within the scope of the protection granted by this Letters Patent.

What is claimed is:

1. An apparatus for cooperative operation with a paint roller assembly, said apparatus comprising:
a main member;
a first end member coupled to said main member, said first end member adapted to be secured to the end of the handle of a paint roller assembly; and
a second end member coupled to said main member, said second end member at least partially spanning across a projected region;
wherein said second end member is adapted to accommodate and support a forearm during painting activities.

2. The apparatus of claim 1, wherein said apparatus is an article of manufacture.

3. The apparatus of claim 1, wherein said first end member comprises threads for inserting said front end member, via rotation, into a threaded receptacle in said paint roller handle.

4. The apparatus of claim 1, wherein said projected area is substantially parallel to said main member.

5. The apparatus of claim 1, further comprising:
a pivot device coupled between said first end member and said main member, said pivot device being adapted to allow axial rotation of said apparatus.

6. The apparatus of claim 1, further comprising:
a pivot device coupled between said first end member and said main member, said pivot device being adapted to allow axial rotation of said apparatus;
wherein said apparatus is an article of manufacture, wherein said first end member comprises threads for inserting said front end member, via rotation, into a threaded receptacle in said paint roller handle, and wherein said projected area is substantially parallel to said main member.

7. The apparatus of claim 1, further comprising:
a second pivot device coupled to said pivot device and said main member adapted to change an angle formed between the centerline of said handle and a defined centerline of said apparatus; and
a locking device coupled to said second pivot device adapted to fix said angle.

8. The apparatus of claim 7, wherein said angle comprises a plurality of fixed angles.

9. The apparatus of claim 7, wherein said second pivot device and said locking device are subsumed by a unit.

10. The apparatus of claim 7, wherein said pivot device, said second pivot device and said locking device are subsumed by a unit.

11. An apparatus for cooperative operation with a paint roller assembly, said apparatus comprising:
a main member;
a first end member coupled to said main member, said first end member adapted to be secured to the end of a paint roller assembly handle;
a second end member coupled to said main member, said second end member at least partially spanning across a projected region; and
an oblique member making an oblique angle relative to said paint roller assembly handle, and coupled between said first end member and said main member;
wherein said oblique member is adapted to be grasped during painting activities, and said second end member is adapted to accommodate and support a forearm during painting activities.

12. The apparatus of claim 11, wherein said apparatus is an article of manufacture.

13. The apparatus of claim 11, wherein said first end member comprises threads for inserting said front end member, via rotation, into a threaded receptacle in said paint roller handle.

14. The apparatus of claim 11, wherein said projected area is substantially parallel to said main member.

15. The apparatus of claim 11, further comprising:
a pivot device coupled between said first end member and said oblique member, said pivot device being adapted to allow axial rotation of said apparatus.

16. The apparatus of claim 11, further comprising:
a pivot device coupled between said first end member and said oblique member, said pivot device being adapted to allow axial rotation of said apparatus;
wherein said apparatus is an article of manufacture, wherein said first end member comprises threads for inserting said front end member, via rotation, into a threaded receptacle in said paint roller handle, and wherein said projected area is substantially parallel to said main member.

17. The apparatus of claim 11, further comprising:
a second pivot device coupled to said pivot device and said oblique member adapted to change an angle formed between the centerline of said handle and a defined centerline of said apparatus; and
a locking device coupled to said second pivot device adapted to fix said angle.

18. The apparatus of claim 1, wherein said main member and said second end member form an integrated loop.

19. The apparatus of claim 1, wherein said main member comprises two fork members spreading out toward said second end member, and said second end member comprises flexible material coupled between said fork members.

20. The apparatus of claim 19, wherein said fork members are retractable.
